(19) United States
(12) Patent Application Publication
(10) Pub. No.: US 2003/0133223 A1
(43) Pub. Date: Jul. 17, 2003

(54) Magnetic recording head with annealed multilayer, high moment structure

(75) Inventor: Michael K. Minor, Gibsonia, PA (US)

Correspondence Address: Benjamin T. Queen, II, Pietragallo, Bosick & Gordon, One Oxford Centre, 38th Floor, 301 Grant Street, Pittsburgh, PA, 15219, US

(73) Assignee: Seagate Technology LLC, Scotts Valley, CA

(21) Appl. No.: 10/337,099

(22) Filed: Jan. 6, 2003

Related U.S. Application Data
(60) Provisional application No. 60/386,771, filed on Jun. 6, 2002.
(60) Provisional application No. 60/346,606, filed on Jan. 8, 2002.

(51) Int. Cl. G11B 5/127

(52) U.S. Cl. 360/125

(57) ABSTRACT

A magnetic recording head includes a write pole having alternating layers of Fe and Co and a return pole magnetically coupled to the write pole. The write pole is annealed and may have a saturation magnetization greater than about 2.45 Tesla. An enhanced moment thin film magnetic structure and a method for forming a thin film magnetic structure are also disclosed.

### CROSS REFERENCE TO RELATED APPLICATION

This application claims the benefit of U.S. Provisional Application Nos. 60/386,771 filed Jun. 6, 2002 and 60/346,606 filed Jan. 8, 2002.

### FIELD OF THE INVENTION

The invention relates to magnetic recording, and more particularly, to a magnetic recording head with an annealed multilayer, high moment structure.

### BACKGROUND OF THE INVENTION

Magnetic recording heads have utility in a magnetic disc drive storage system. Most magnetic recording heads used in such systems today are “longitudinal” magnetic recording heads. Longitudinal magnetic recording in its conventional form has been projected to suffer from superparamagnetic instabilities at densities above approximately 40 Gbit/in². It is believed that reducing or changing the bit cell aspect ratio will extend this limit up to approximately 100 Gbit/in². However, for recording densities above 100 Gbit/in², different approaches will likely be necessary to overcome the limitations of longitudinal magnetic recording.

An alternative to longitudinal recording is “perpendicular” magnetic recording. Perpendicular magnetic recording is believed to have the capability of extending recording densities well beyond the limits of longitudinal magnetic recording. Perpendicular magnetic recording heads for use with a perpendicular magnetic storage medium may include a pair of magnetically coupled poles, including a write pole having a small bottom surface area and a flux return pole having a larger bottom surface area. A coil having a plurality of turns is located adjacent to the write pole for inducing a magnetic field between that pole and a soft underlayer of the storage media. The soft underlayer is located below the hard magnetic recording layer of the storage media and enhances the amplitude of the field produced by the main pole. This, in turn, allows the use of storage media with higher coercive force, consequently, more stable bits can be stored in the media. In the recording process, an electrical current in the coil energizes the main pole, which produces a magnetic field. The image of this field is produced in the soft underlayer to enhance the field strength produced in the magnetic media. The flux density that diverges from the tip into the soft underlayer returns through the return flux pole. The return pole is located sufficiently far apart from the main write pole such that the material of the return pole does not affect the magnetic flux of the main write pole, which is directed vertically into the hard layer and the soft underlayer of the storage media.

Saturation magnetization is an important property of recording heads and is directly related to the areal density that may be achieved by a head-media combination. Therefore, in selecting a material or structure to form at least a portion of either a write pole of a longitudinal recording head or the write pole of a perpendicular magnetic recording head, it is desirable to have a material or structure that exhibits a large/high saturation magnetization (4πMₛ), also generally referred to as “moment” or “magnetic moment”. For example, one of the highest known saturation magnetizations at room temperature is exhibited by the bulk alloy Fe₆₅Co₃₅ which has a saturation magnetization value of approximately 2.45T. In view of the desire to continuously increase the areal density, it would be advantageous, therefore, to have a material or structure that has an enhanced or increased saturation magnetization value.

There is identified, therefore, a need for an improved magnetic recording head that overcomes limitations, disadvantages, and/or shortcomings of known magnetic recording heads. There is also identified a need for an improved material or structure having an enhanced saturation magnetization or moment in comparison to known materials or structures.

### SUMMARY OF THE INVENTION

Embodiments of the invention meet the identified need, as well as other needs, as will be more fully understood following a review of the specification and drawings.

In accordance with an aspect of the invention, a magnetic recording head comprises a write pole having alternating layers of Fe and Co and a return pole magnetically coupled to the write pole. In accordance with the invention, the write pole layers of Fe and Co are annealed to, for example, promote uniaxiality within the layers. The write pole may have a saturation magnetization greater than about 2.45 Tesla.

In accordance with another aspect of the invention, an enhanced moment thin film magnetic structure comprises alternating layers of x ÅFe and y ÅCo, wherein 2.0≦x≦20.0 and 2.0≦y≦12.0. The thin film structure is annealed to, for example, promote uniaxiality within the layers.

In accordance with yet another aspect of the invention, a method for forming a thin film magnetic structure comprises providing a substrate, depositing a layer of Fe on the substrate, depositing a layer of Co on the layer of Fe, depositing an additional layer of Fe on the layer of Co and depositing an additional layer of Co on the additional layer of Fe. The method also includes annealing the deposited layers of Fe and Co. The annealing may include use of a magnetic field having a field strength greater than about 50 Oe. The annealing may be done, for example, at a temperature greater than about 250° C. for a sufficient period of time which will allow substitutional diffusion of Fe in Co. Because diffusion is needed, higher temperatures result in faster diffusion and are desired, thus the temperature of annealing is only limited by the maximum processing temperature of components within the head build. The invention may include a thin film magnetic structure made according to the described method of the invention. In addition, the invention may include a magnetic recording head having a thin film magnetic structure made according to the method of the present invention. Also, the invention may include a magnetic recording medium having a thin film magnetic structure made according to the method of the present invention.

### BRIEF DESCRIPTION OF THE DRAWINGS

FIG. 1 is a pictorial representation of a disc drive system that may utilize a magnetic recording head in accordance with the invention.

FIG. 2 is a partially schematic side view of a perpendicular magnetic recording head and a perpendicular magnetic recording medium.

FIG. 3 illustrates sheet resistance versus Co content.

FIGS. 4a-4c illustrate high-angle X-ray diffraction scans for film sets constructed as described herein.

FIGS. 5a-5c illustrate rocking curves for film sets constructed as described herein.

FIG. 6 illustrates saturation magnetization (4πMₛ) versus Co content for film sets as described herein and for bulk alloys.

FIG. 7 illustrates saturation magnetization enhancement over Fe₆₅Co₃₅ versus Co content.

FIG. 8 is a partially schematic side view of a perpendicular magnetic recording head and a perpendicular magnetic recording medium in accordance with the invention.

FIG. 9 illustrates a B-H loop, along the hard axis and the easy axis, of the as-deposited FeCo multilayer structure wherein n=5.5 angstroms.

FIG. 10 illustrates a B-H loop of the FeCo multilayer structure, after annealing, wherein n=5.5 angstroms.

FIG. 11 illustrates sheet resistance (Rₛₕₑₑₜ) and a percent change in sheet resistance after annealing versus the Fe and Co period, n, in the as-deposited and annealed states.

FIG. 12 illustrates easy and hard axis coercivity (H_{c}) versus the Fe and Co period, n, for the as-deposited and annealed Film Set 3.

FIG. 13 illustrates H_{K} and the hard axis squareness (SQ_{hard axis}) versus the Fe and Co period, n, in the as-deposited and annealed states.

FIG. 14 illustrates easy axis flux as measured by a B-H looper and the percent change in the flux after anneal versus the Fe and Co period, n, in the as-deposited and annealed states.

FIG. 15 illustrates the magnetic moment (4πMₛ) and the percent of moment enhancement over the bulk alloy Fe₆₅Co₃₅ having a moment of approximately 2.45 Tesla versus the Fe and Co period, n.

### DETAILED DESCRIPTION OF THE INVENTION

The invention provides an annealed multilayer, high moment structure, and more particularly may provide a magnetic recording head with an annealed multilayer, high moment structure. The invention is particularly suitable for use with a magnetic disc drive storage system, although it will be appreciated that the annealed multilayer, high moment structure may be used in other devices or systems where it may be advantageous to employ such a structure. A recording head, as used herein, is generally defined as a head capable of performing read and/or write operations. Longitudinal magnetic recording, as used herein, generally refers to orienting magnetic domains within a magnetic storage medium substantially parallel to the direction of travel of the recording head and/or medium. Perpendicular magnetic recording, as used herein, generally refers to orienting magnetic domains within a magnetic storage medium substantially perpendicular to the direction of travel of the recording head and/or recording medium.

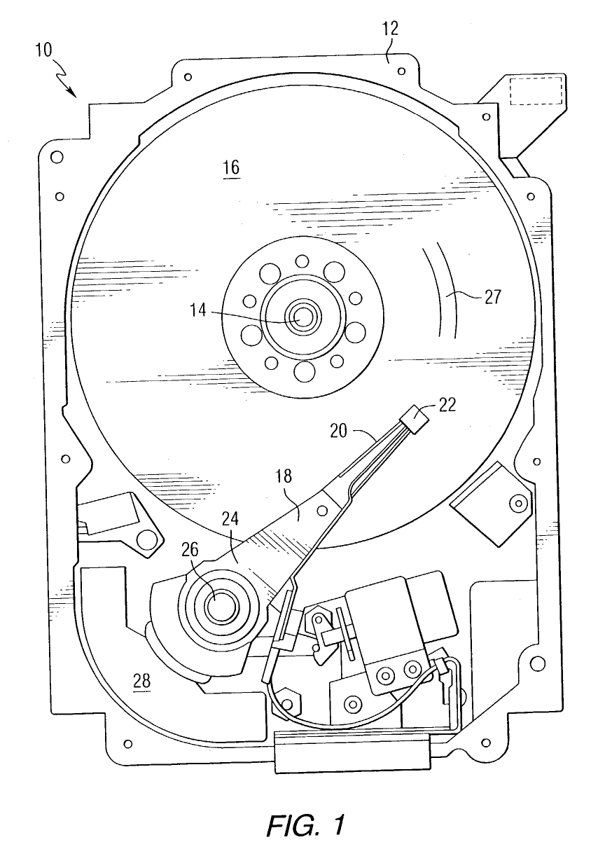

FIG. 1 is a pictorial representation of a disc drive 10 that can utilize a perpendicular magnetic recording head in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing, in this case a magnetic disc. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

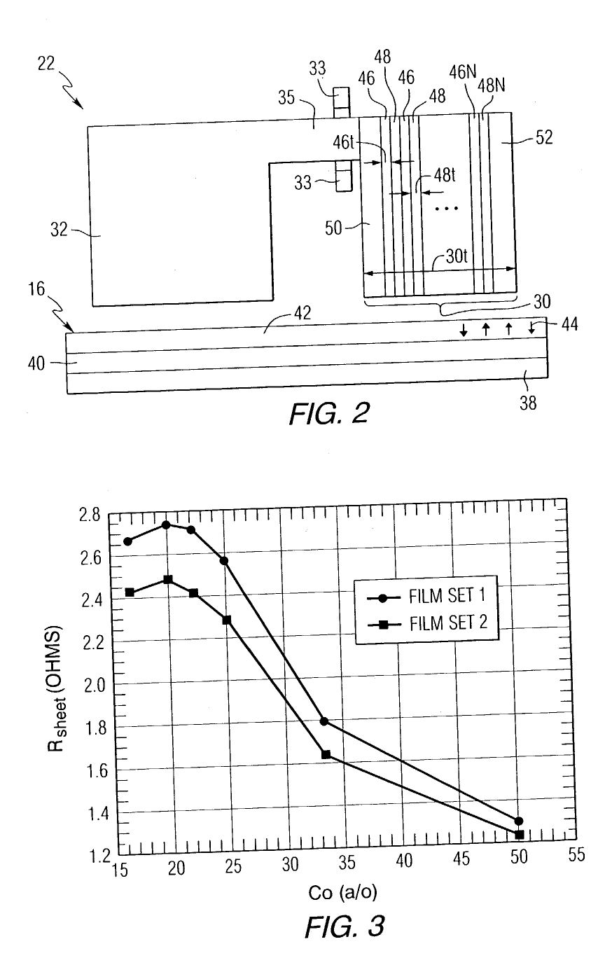

FIG. 2 is a partially schematic side view of the magnetic recording head 22 constructed as a perpendicular recording head, and the recording medium 16 constructed as a perpendicular magnetic recording medium. Although an embodiment of the invention is described herein with reference to a perpendicular magnetic recording head, it will be appreciated that aspects of the invention may also be used in conjunction with other type recording heads, such as, for example, a longitudinal magnetic recording head. In addition, it will be appreciated that aspects of the invention may also be used in conjunction with other components of a magnetic recording system, such as, for example, forming a portion of the magnetic recording medium where it is advantageous to employ therein a high moment magnetic structure, such as a soft underlayer used with perpendicular recording media. Specifically, the recording head 22 includes a writer section comprising a write pole 30 and a return or opposing pole 32 that are magnetically coupled by a yoke or pedestal 35. A magnetizing coil 33 surrounds the yoke or pedestal 35 for energizing the recording head 22. The recording head 22 also includes a read head, not shown, which may be any conventional type read head as is generally known in the art.

Still referring to FIG. 2, the perpendicular magnetic recording medium 16 is positioned under the recording head 22. The recording medium 16 includes a substrate 38, which may be made of any suitable material such as aluminum, ceramic glass or amorphous glass. A soft magnetic underlayer 40 is deposited on the substrate 38. The soft magnetic underlayer 40 may be made of any suitable material having, for example, a relatively high moment and high permeability, such as FeCo, NiFeCo or an Fe-Co multilayer. A hard magnetic recording layer 42 is deposited on the soft underlayer 40, with the perpendicular oriented magnetic domains 44 contained in the hard layer 42. Suitable hard magnetic materials for the hard magnetic recording layer 42 may include at least one material selected from CoCr, FePd, CoPd, CoFePd, CoCrPd, or CoCrPt.

The write pole 30 is a laminated or multilayer structure. Specifically, the write pole 30 includes alternating layers 46 of Fe and layers 48 of Co. The alternating layers 46 and 48 may be repeated up to 46N and 48N times where N=1, 2, 3 . . . such that the write pole 30 may have a thickness 30 t in the range from about 50 angstroms to about 5,000 angstroms. The layer 46 of Fe may have a thickness 46 t in the range from about 1.0 angstroms to about 40.0 angstroms. The layer 48 of Co may have a thickness 48 t in the range from about 1.0 angstroms to about 20.0 angstroms.

The write pole 30 may also include an underlayer 50 which serves as a texture enhancing layer which can enhance certain crystallographic textures in the write pole 30. This texture enhancement can improve the magnetic properties of the write pole 30, which is desirable. The underlayer 50 may be formed of, for example, NiFeCr, Cr, MgO or other similar materials for providing the texture enhancement. The underlayer 50 may have a thickness in the range from about 20 angstroms to about 200 angstroms.

The write pole 30 may also include a cap layer 52 to prevent oxidation of the layers 46 and 48 that form the write pole 30. The cap layer 52 may be formed of, for example, NiFeCr, Ta, Cr, MgO or any other similar material with oxidation resistance.

Reference is made to FIGS. 3-7. Specifically, the write pole 30, as described herein, is illustrated by forming two film sets with the following structures:

| | |
|---|---|
| Si\SiO₂\FeₙCo\50 Å NiFeCr cap | n = 1, 2, 3, 3.5, 4, and 5 (Film Set 1) |
| Si\SiO₂\50 Å NiFeCr underlayer\FeₙCo\50 Å NiFeCr cap | n = 1, 2, 3, 3.5, 4, and 5 (Film Set 2) |

Generally, Film Sets 1 and 2 were prepared via dc magnetron physical vapor deposition (i.e. dc magnetron sputtering) from pure Fe and Co targets. The deposition pressure was 3.0 mTorr and ultra high purity argon was used as the process gas. The substrates were 150 mm round Si (100) with 5,000 Å of thermal oxide. The Fe-Co multilayered structure was formed by positioning the substrate under the Fe target where n×3.5 angstroms (wherein n=1, 2, 3, 3.5, 4 and 5) was deposited. The substrate was then positioned under the Co target where 3.5 angstroms was deposited. This process was repeated until a total film thickness of approximately 1000 angstroms was achieved. It will be appreciated that the thickness of the layers 46 of Fe and the layers 48 of Co may be varied in accordance with the thickness ranges set forth herein and that the total film thickness, i.e., the thickness of the write pole 30, may also be varied in accordance with the thickness range set forth herein.

In order to compare the nominal and measured Co a/o for the depositions used to form the Film Sets 1 and 2 described herein, the chemical composition was measured via energy dispersive spectrometry (EDS). Table 1 shows the film and the nominal and measured Co content:

TABLE 1
Nominal And Measured Co Content For As-Deposited FeCo MLs

| Film | Nominal Co (a/o) | Measured Co (a/o) |
|---|---|---|
| FeCo | 50.0 | 51.0 |
| Fe₂Co | 33.3 | 34.6 |
| Fe₃Co | 25.0 | 26.3 |
| Fe_{3.5}Co | 22.2 | 22.4 |
| Fe₄Co | 20.0 | 19.8 |
| Fe₅Co | 16.7 | 18.3 |

EDS is generally cosidered to be accurate within about 2 atomic percent (a/o), therefore, the data shows that the Co content and the multilayer structures that comprise the films is close to that which was targeted.

FIG. 3 illustrates the sheet resistance for Film Set 1 and Film Set 2 versus the nominal Co content. Specifically, FIG. 3 illustrates that both sets of films exhibit a similar trend with a peak in sheet resistance at approximately 20 a/o of Co (Fe₄Co). Advantageously, this is a similar trend as exhibited by FeCo bulk alloys. In addition, for a given Co content, FIG. 3 illustrates that Film Set 2 having the NiFeCr underlayer exhibits a lower sheet resistance than Film Set 1 that is formed without the underlayer.

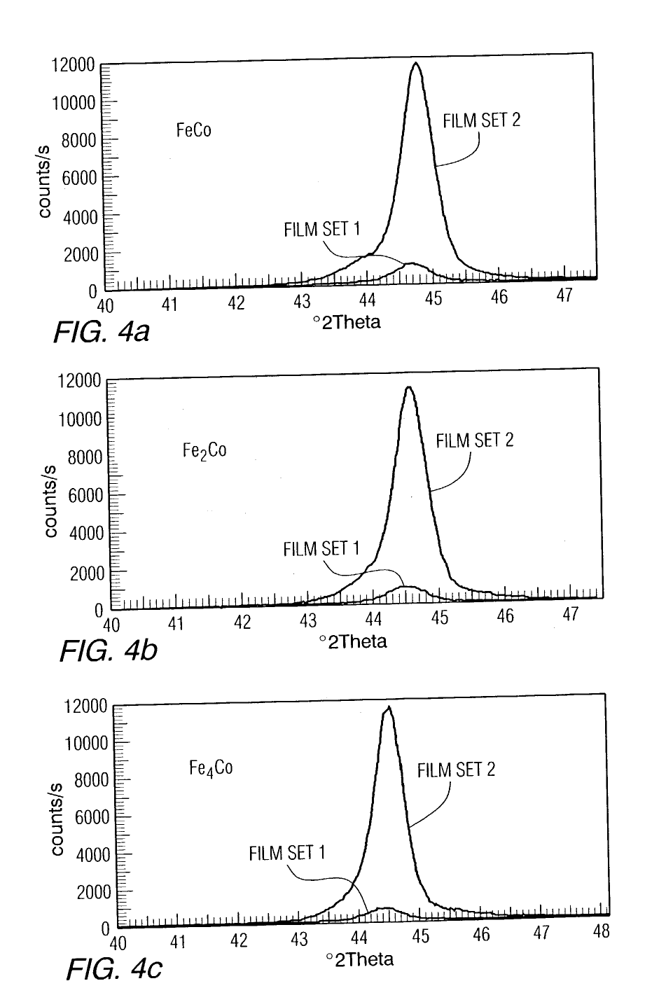

FIGS. 4a-4c illustrate high angle X-ray diffraction scans for FeCo, Fe₂Co, and Fe₄Co for Film Sets 1 and 2. These figures illustrate the (110) BCC α-Fe peak for the Film Sets 1 and 2. Specifically, FIGS. 4a-4c illustrate that the intensity of the (110) peak of the films with the NiFeCr underlayer, i.e., Film Set 2, is larger than the films with no underlayer. In addition, as more Fe is added, the d-spacing between the interatomic planes normal to the film plane become larger which is also existent in FeCo bulk alloys.

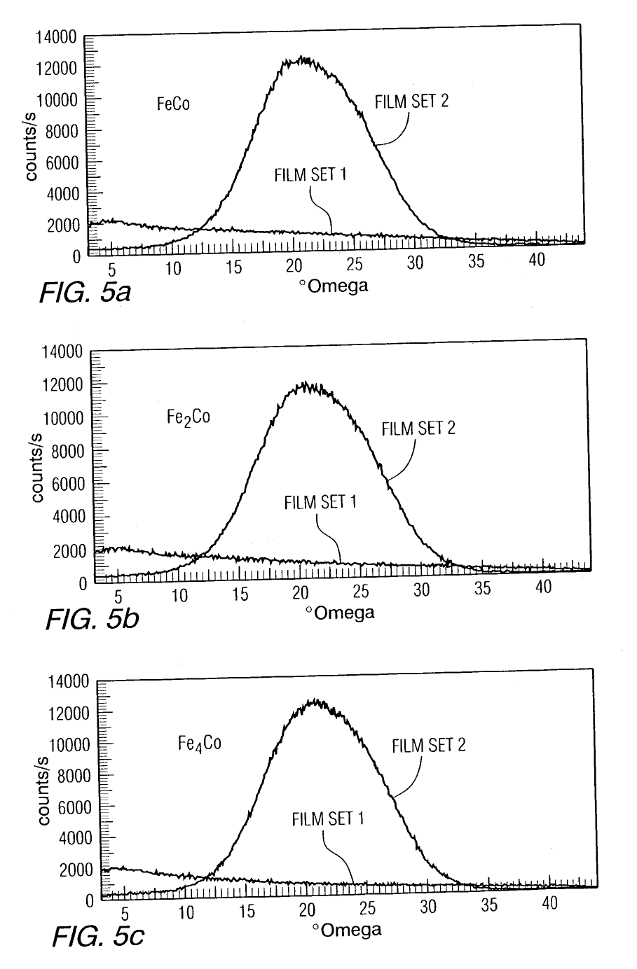

FIGS. 5a-5c illustrate the rocking curves for the same films illustrated in FIGS. 4a-4c. Specifically, these figures illustrate that the films having the NiFeCr underlayer, i.e., Film Set 2, have some degree of an in-plane (110) texture while the films without the underlayer, i.e., Film Set 1, are more randomly oriented in the plane of the film. Presumably, the NiFeCr underlayer exhibits a lattice which promotes the (110) texture of the FeCo multilayers. Other orientations of the FeCo multilayers are possible which may or may not exhibit higher magnetization. An example of this would be the (100) orientation of the FeCo multilayers formed on an MgO underlayer.

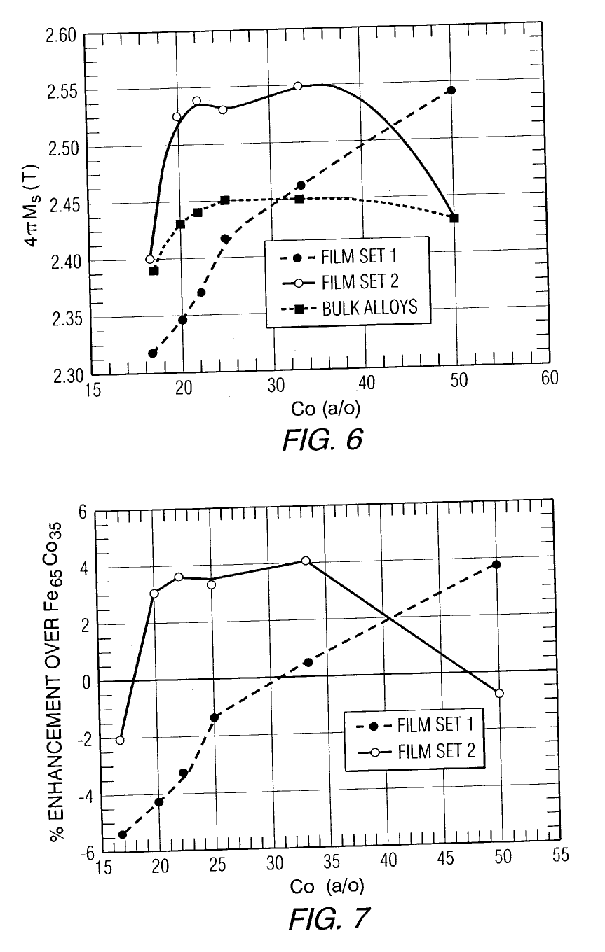

FIG. 6 illustrates the saturation magnetization (4 πMₛ) of the Film Sets 1 and 2 and FeCo bulk alloys versus Co content. The saturation magnetization was measured on a SQUID magnetometer. To measure the saturation magnetization, a method was employed which applies a field normal to the plane of the film. This is essentially the demag field which is approximately equal to the saturation magnetization when the film is saturated. Specifically, FIG. 6 illustrates the FeCo bulk alloys which exhibit the highest known saturation magnetization at ambient temperature, e.g., 2.45 Tesla. FIG. 6 also illustrates that the multilayer structure without an underlayer, i.e., Film Set 1, exhibit an enhanced moment above 2.45 Tesla at approximately greater than about 32 a/o of Co. For example a moment of approximately 2.47 Tesla for about 33 a/o of Co and a moment of approximately 2.54 Tesla for about 50 a/o of Co. The multilayer structures having an underlayer, i.e., Film Set 2, exhibit an enhanced moment over a wide region of Co concentrations, e.g., between about 17 a/o Co and about 48 a/o Co. For example a moment of approximately 2.53 Tesla for about 20 a/o of Co and a moment of approximately 2.55 Tesla for about 33 a/o of Co. This indicates that the crystallographic orientation of the films is important for the moment enhancement. Accordingly, it will be appreciated that by forming a structure, such as write pole 30, having alternating layers of Fe and Co that a saturation magnetization greater than about 2.45 Tesla can be obtained.

FIG. 7 illustrates the percent enhancement in saturation magnetization compared to a Fe₆₅Co₃₅ bulk alloy having a saturation magnetization of 2.45 Tesla at ambient temperature versus Co content for Film Sets 1 and 2. Specifically, FIG. 7 illustrates that a saturation magnetization or moment enhancement of approximately 4% over the highest known saturation magnetization exhibited by the Fe₆₅Co₃₅ can be obtained by forming a structure having alternating layers of Fe and Co.

For the Film Sets 1 and 2, the enhanced saturation magnetization results at least in part from two competing effects: the large enhancement of the magnetic moments of the Fe atoms adjacent to Co atoms and the rapid loss of the enhanced Fe moment values back to their Fe bulk moment value for atoms away from the Fe-Co interface. The Co moments are not as sensitive to their environment and are not much different from their bulk value. However, in the multilayer structure of the present invention, a balance is achieved with variation of the relative number of Fe to Co layers as an added degree of freedom. An important advantage of the multilayer structures of the present invention over bulk alloys comes from the reduced dimensionality of the Fe and Co atoms in the layered structures. This enhances the electronic density of states to enhance both their spin and orbital magnetic moments which leads to the enhancement of the moment observed in the multilayered structures.

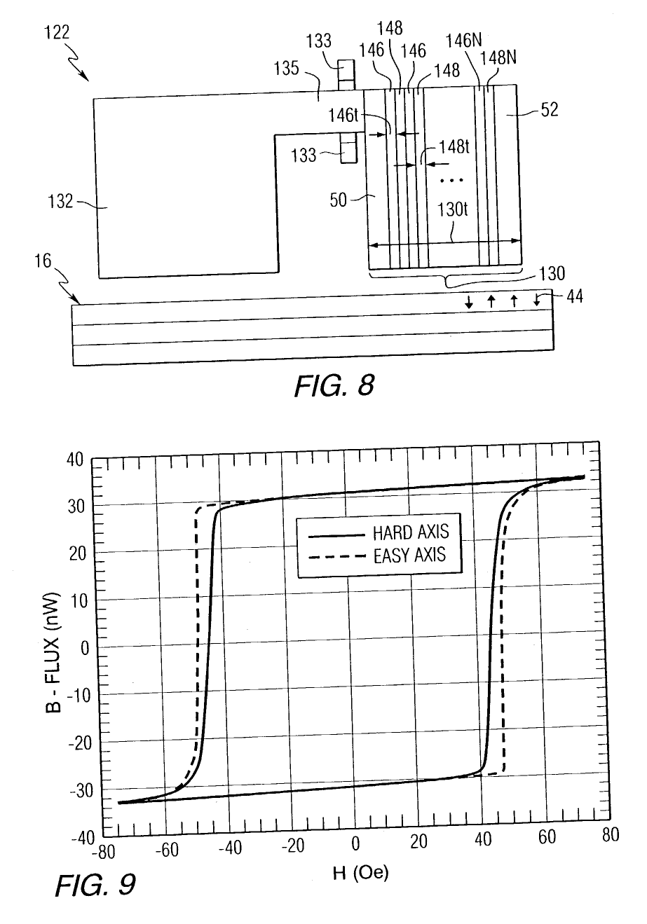

Further moment enhancement of the write pole 30 may also be achieved by annealing the write pole 30. Specific details and advantages of annealing the described multilayer structures, such as used for forming write pole 30, will now be described in more detail with particular reference to FIGS. 8-15 and another embodiment of the invention constructed in the form of write pole 130.

In accordance with an aspect of the invention, FIG. 8 illustrates a partially schematic side view of a magnetic recording head 122 constructed as a perpendicular recording head for use in conjunction with the recording medium 16. Although this embodiment of the invention is described herein with reference to a perpendicular magnetic recording head for orienting the magnetic domains 44 in the recording medium 16, it will be appreciated that aspects thereof may also be used in conjunction with other type recording heads such as, for example, a longitudinal magnetic recording head. In addition, it will be appreciated that aspects of the invention may also be used in conjunction with other components of a magnetic recording system, such as, for example, forming a portion of the magnetic recording medium where it is advantageous to employ therein a high moment magnetic structure. Aspects of the invention may also be used in conjunction with other systems besides magnetic recording systems where it may be advantageous to employ a high moment magnetic structure.

The recording head 122 includes a writer section comprising a write pole 130 and a return or opposing pole 132 that are magnetically coupled by a yoke or pedestal 135. A magnetizing coil 133 surrounds the yoke or pedestal 135 for energizing the recording head 122. The recording head 122 may also include a read head, not shown, which may be any conventional type read head as is generally known in the art.

In accordance with the invention, the write pole 130 is a laminated or multilayer structure. Specifically, the write pole 130 includes alternating layers 146 of Fe and layers 148 of Co. The alternating layers 146 and 148 may be repeated up to 146N and 148N times where N equals 1, 2, 3 . . . such that the write pole 130 may have a thickness 130 t in the range from about 50 angstroms to about 5000 angstroms. The layers 146 of Fe may each have a thickness of 146 t in the range from about 2.0 angstroms to about 20.0 angstroms. The layers 148 of Co may each have a thickness 148 t in the range from about 2.0 angstroms to about 12.0 angstroms.

The write pole 130 may also include the underlayer 50 and the cap layer 52 as previously described herein.

The write pole 130 may be annealed in order to enhance the magnetic moment thereof. As will be described herein, the enhanced moment is achieved by annealing the write pole 130 which alters the multilayers from a normally magnetically isotropic state into a magnetically soft and uniaxial state. The annealing may be performed on the write pole 130 using conventional annealing techniques as is generally known. In accordance with the invention, the annealing may be carried out in the presence of a magnetic field having, for example, a magnetic field strength greater than about 50 Oe. The strength of the magnetic field is selected such that it is sufficient to magnetize the layers 146 and 148 in-plane to achieve the desired magnetically soft and uniaxial state. The annealing of the write pole 130 may be done, for example, at a temperature greater than about 250° C. for a sufficient period of time which will allow substitutional diffusion of Fe in Co. Because diffusion is needed, higher temperatures result in faster diffusion and are desired, thus the temperature of annealing may only be limited by the maximum processing temperature of components within the head build. For example, the annealing may be done at a temperature in the range of about 250° C. to about 1000 ° C. and for a period of time of about 1 hour to about 10 hours. It will be appreciated that the temperature and the period of time for annealing may be varied as desired for altering the magnetic structure of the layers 146 and 148.

To illustrate the invention, reference is made to FIGS. 9-15. Specifically, the write pole 130, as described herein, is illustrated by forming a film set with the following structure: Si\SiO₂\((n Å Fe\n Å Co)x(1000/2n))\200 Å NiFeCr cap where n=3.5, 5.5, 6.5, 7.0, 7.5, 8.5, 9.5, 10.5 and 11.5 (Film Set 3)

Film Set 3 was prepared via a physical vapor deposition process from pure Fe and Co targets. Ultra-high purity argon was used as the process gas and the deposition pressure was 3.0 mTorr. The substrate was placed under the Fe target where n angstroms of Fe were deposited. The substrate was then placed under the Co target where n angstroms of Co were deposited. The process was repeated until the total thickness of the FeCo multilayer film was 1000 angstroms. It will be appreciated that the thickness of the layers 146 of Fe and the layers 148 of Co may be varied in accordance with the thickness ranges set forth herein and that the total film thickness, i.e., the thickness of the write pole 130, may also be varied in accordance with the thickness ranges set forth herein.

FIG. 9 illustrates the B-H loop, along the hard axis and the easy axis, of the as-deposited FeCo multilayer structure, i.e., prior to annealing, wherein n=5.5 angstroms. In the as-deposited state, the FeCo multilayer structure exhibits a moment of approximately 2.54 Tesla, which is an enhancement of approximately 3.7% over the bulk alloy Fe₆₅Co₃₅ having an approximate moment of 2.45 Tesla. Magnetically, the FeCo multilayer structure resembles the bulk FeCo alloys in that the FeCo multilayer structure is generally isotropic.

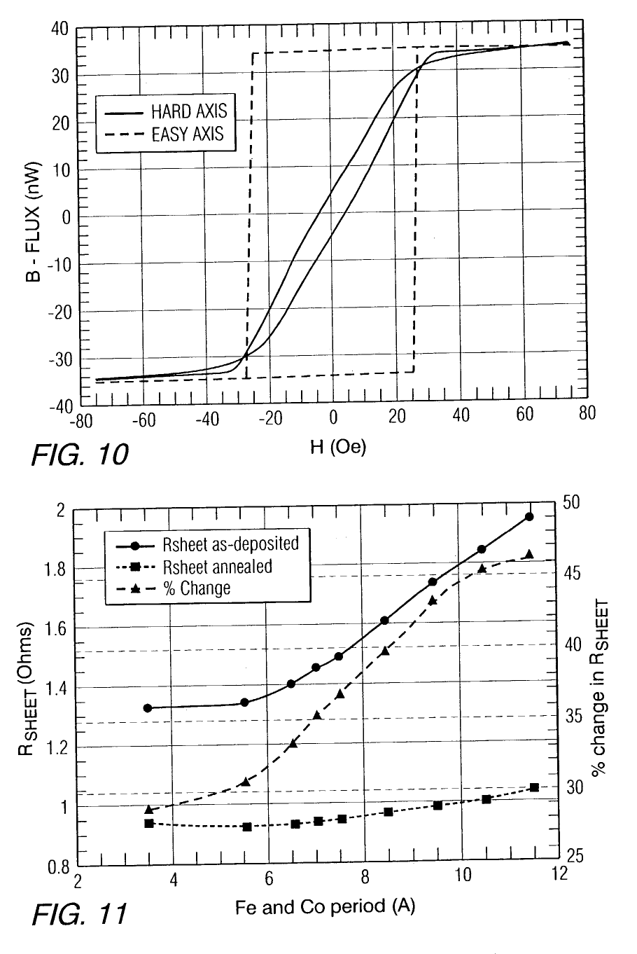

FIG. 10 illustrates the B-H loop of the FeCo multilayer structure wherein n=5.5 angstroms, following the annealing thereof. The annealing was performed in a magnetic field at 300° C. for four hours. As illustrated by the B-H loop, the film became magnetically soft and uniaxial. As can be appreciated, the anneal results in a structural change because it induces the desired uniaxiality. In order for FeCo alloys to become soft and uniaxial, the large magnetocrystalline anisotropy must be overcome. This is achieved via the formation of the CsCl type FeCo ordered structure where the CsCl structure refers to the crystal structure of the ordered FeCo unit cell. The ordered structure would consist of Fe atoms at the corners of a cube with a Co atom at the body-centered position. At the simplest level, the FeCo ordered structure is simple cubic.

FIG. 11 illustrates the sheet resistance (Rₛₕₑₑₜ) and the percent change in sheet resistance after annealing versus the Fe and Co period, n, in the as-deposited and annealed states. As shown, the sheet resistance increases with increasing period in the as-deposited films. After the annealing, however, the sheet resistance drops dramatically to values at or just below 1 ohmn. The overall change in the sheet resistance varies anywhere from approximately 30% to approximately 45%. This data indicates that the Film Set 3 is tending toward a similar structural state after the annealing. This type of behavior is also indicated by the magnetic properties of the Film Set 3, such as easy and hard axis coercivities as shown in the figures described herein. The large changes in Rₛₕₑₑₜ also indicate a significant microstructural change which indirectly supports the formation of the ordered FeCo phase after annealing.

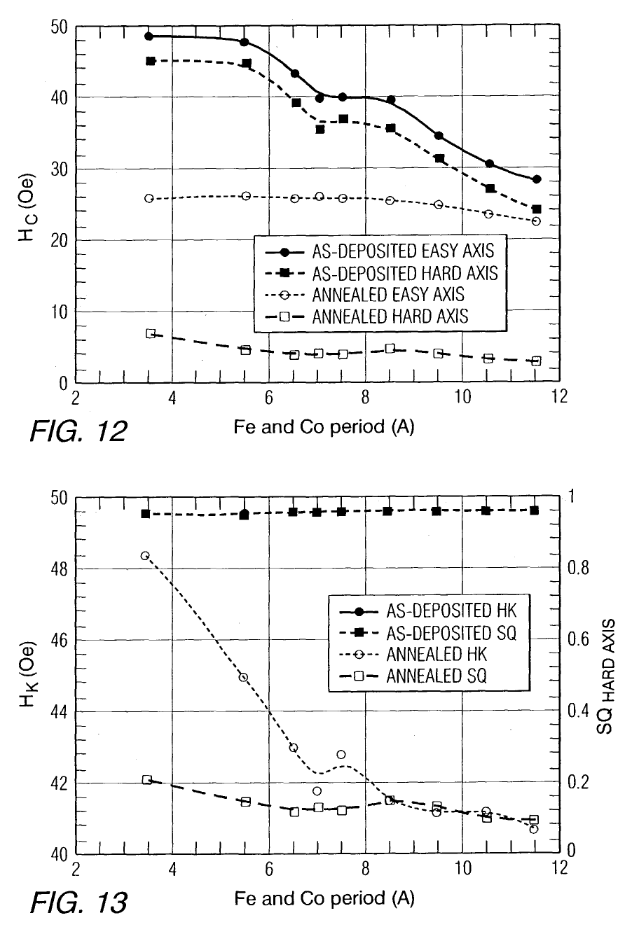

FIG. 12 illustrates the easy and hard axis coercivity (H_{c}) versus the Fe and Co period, n, for the as-deposited and annealed Film Set 3. In the as-deposited films, the easy and hard axis coercivities tend to decrease with increasing period. The values are approximately the same which is indicative of the isotropic magnetics. After annealing, the easy axis coercivity decreases to approximately 26 Oe and the hard axis coercivity decreases to approximately 5 Oe. This reduction in easy and hard axis coercivities as well as a significant difference between the values indicate soft and uniaxial magnetic properties after annealing.

FIG. 13 illustrates H_{K} (the value of an applied field to reach magnetic saturation along the hard axis) and the hard axis squareness (SQ_{hard axis}) versus the Fe and Co period, n, in the as-deposited and annealed states. The as-deposited structures are isotropic and do not exhibit any H_{K}. After annealing, Film Set 3 exhibits an H_{K} which decreases with increasing period. The isotropic to uniaxial transition is also shown by the hard axis squareness. In addition to the uniaxial transformation, the anneal also enhances the magnetic moment further. The magnetic changes after annealing shown in FIGS. 12 and 13 further support a significant microstructural change since magnetic properties are governed directly by the microstructure.

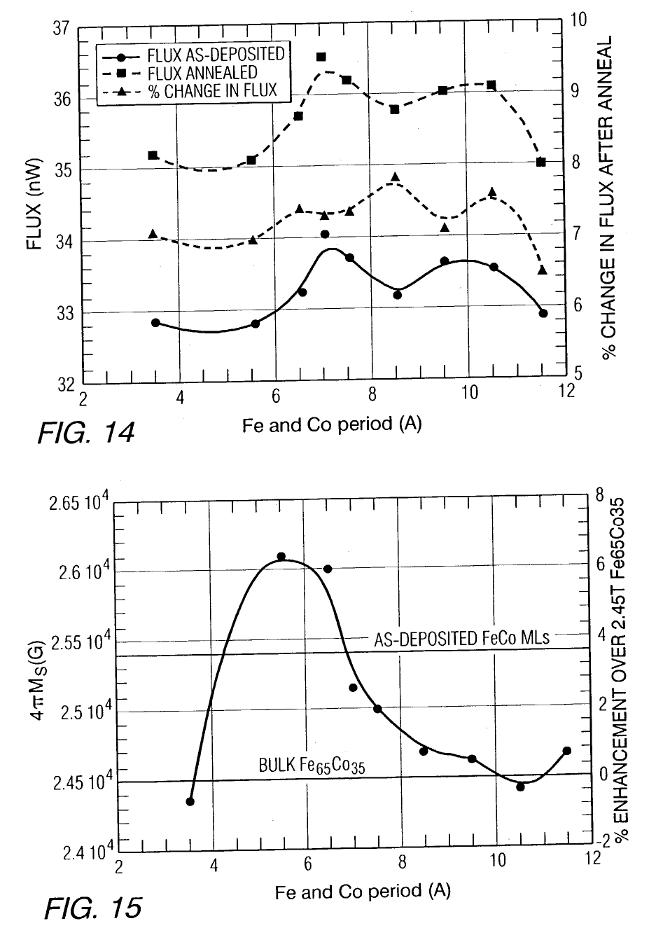

FIG. 14 illustrates the easy axis flux, as measured by a B-H looper and the percent change in the flux after anneal versus the Fe and Co period, n, in the as-deposited and annealed states. For all periods in the Film Set 3, the flux increased after annealing indicating an overall increase in the magnetic moment. The increase in flux was approximately 7% for the Film Set 3.

FIG. 15 illustrates the moment (4πMₛ) and the percent of moment enhancement over the bulk alloy Fe₆₅Co₃₅ having a moment of approximately 2.45T versus the Fe and Co period, n. Specifically, FIG. 15 illustrates that the moment is enhanced above 2.45 Tesla over a wide range of periods. The Film Set 13 with a period of 5.5 angstroms exhibits the largest moment of approximately 2.61 Tesla, which is approximately 6.5% above the moment for the bulk alloy Fe₆₅Co₃₅.

Whereas particular embodiments have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims.

What is claimed is:

1. A magnetic recording head, comprising:
a write pole having alternating layers of Fe and Co, wherein said write pole is annealed and has a saturation magnetization greater than about 2.45; and
a return pole magnetically coupled to said write pole.

2. The magnetic recording head of claim 1, wherein said write pole has a thickness from about 50 angstroms to about 5,000 angstroms.

3. The magnetic recording head of claim 1, wherein the layer of Fe has a thickness from about 2.0 angstroms to about 20.0 angstroms.

4. The magnetic recording head of claim 1, wherein the layer of Co has a thickness from about 2.0 angstroms to 12.0 angstroms.

5. The magnetic recording head of claim 1, wherein said write pole includes a cap layer formed of a material selected from the group consisting of NiFeCr, Ta, Cr or MgO.

6. The magnetic recording head of claim 1, wherein said write pole includes an underlayer formed of a material selected from the group consisting of NiFeCr, Cr or MgO.

7. An enhanced moment thin film magnetic structure, comprising:
alternating layers of x ÅFe and y ÅCo, wherein 2.0≦x≦20.0 and 2.0≦y≦12.0, and wherein said multilayer structure is annealed and has a saturation magnetization greater than about 2.45 Tesla.

8. A method for forming a thin film magnetic structure, comprising:
providing a substrate;
depositing alternating layers of Fe and Co on the substrate; and
annealing the deposited alternating layers of Fe and Co such that the thin film magnetic structure has a saturation magnetization greater than about 2.45 Tesla.

9. The method of claim 8, further including depositing the layers of Fe to have a thickness from about 2.0 angstroms to about 20.0 angstroms.

10. The method of claim 8, further including depositing the layers of Co to have a thickness from about 2.0 angstroms to about 12.0 angstroms.

11. The method of claim 8, further including depositing the layers of Fe and Co to form the thin film magnetic structure having a thickness in the range of about 50 angstroms to about 5,000 angstroms.

12. The method of claim 8, further including forming a cap layer adjacent the thin film magnetic structure.

13. The method of claim 8, further including forming an underlayer adjacent the thin film magnetic structure.

14. The method of claim 8, further including annealing the layers of Fe and Co in a magnetic field.

15. The method of claim 14, wherein the magnetic field for annealing is greater than about 50 Oe.

16. The method of claim 8, further including annealing the layers of Fe and Co at a temperature of about 250° C. to about 1000° C.

17. The method of claim 8, further including annealing the layers of Fe and Co for a period of about 1 hour to about 10 hours.

18. A thin film magnetic structure made according to the method of claim 8.

19. A magnetic recording head including a thin film magnetic structure made according to the method of claim 8.

20. A magnetic recording medium including a thin film magnetic structure made according to the method of claim 8.
